(19) United States
(12) Patent Application Publication
(10) Pub. No.: US 2015/0262189 A1
(43) Pub. Date: Sep. 17, 2015

(54) ONLINE COMMUNITY-BASED KNOWLEDGE CERTIFICATION METHOD AND SYSTEM

(71) Applicant: Adrianus Marinus Hendrikus (Menno) Vergeer, Utrecht (NL)

(72) Inventor: Adrianus Marinus Hendrikus (Menno) Vergeer, Utrecht (NL)

(21) Appl. No.: 14/205,334

(22) Filed: Mar. 11, 2014

(51) Int. Cl. G06Q 30/00; G09B 7/00

(52) U.S. Cl. CPC G06Q 30/018; G09B 7/00

(57) ABSTRACT

An online knowledge verification system, method and software system product provides self-generating community-based knowledge certification. The system can be web-based and includes an infrastructure that allows users to identify and import into the system information descriptive of virtually unlimited content media for which knowledge certification can be established. The system includes a Question Preparation Engine by which questions and answers for an identified content medium are prepared for supporting the certification process. A Question Judgment Engine permits users to provide endorsement scores for the value of questions provided by other users for each content medium. Testing Engines are provided for testing the knowledge of users, using the prepared questions and answers having sufficient endorsement from the community and providing certificates for users who pass the tests for that particular content medium. The system permits users to share those certificates with other users of the community, as well as contacts on social media websites.

### FIELD OF THE INVENTION

This application relates generally to education, and more specifically to online community-based certification of knowledge.

### BACKGROUND OF THE INVENTION

Education is the cornerstone of a prosperous citizenry. Notwithstanding the exponential increase in the availability of information globally via access to the World Wide Web, as well as the resulting decline in the cost of that information, the cost of a traditional education has continued to increase far beyond increases in the relative cost of living. Thus, the number of people that have access to a traditional education is limited, and those who manage to obtain one are saddled with enormous debt before they even enter the workforce.

The value in a traditional education is largely rooted in the resulting verification of the knowledge a student acquires through that education. That is, students are tested to determine whether they understand the subject matter they are studying and the information generally disseminated in the courses in which they are enrolled. If the tests are sufficiently passed in all courses taken, they are ultimately awarded a degree to represent the verification of that knowledge. They are then able to share that certification from the school with potential employers, professional organizations, alumni associations and the like.

In addition to the prohibitive costs associated with a traditional education, the number of students that are even accepted into degree programs for a given school is significantly limited. The scope of the subject matter covered and verified to achieve a degree in a particular discipline is also restricted by the school, even to the point of specifying the particular text books or other sources of information that will be used as a reference in a particular course. This is true notwithstanding the inexpensive availability of far more sources of content information concerning the subject matter than the one chosen by the professor for the course.

More recently, a proliferation of massive online courses and degree programs over the Internet has occurred. These programs have made information and knowledge verification available to many more people because they are significantly less expensive and more convenient. Notwithstanding, they still operate in much the same way as more traditional educational programs. They limit the scope of the information covered, and they provide verification through testing and ultimately in the form of a degree.

Online communities have also proliferated in recent years. People often participate in these communities through discussions of topics of interests on websites that provide forums such as message boards. Communities of like-minded consumers also provide opinions and reviews on products ranging from consumer goods to content-based media such as books, movies and music. These interests and commentary have now been linked to, and can be shared through, social media sites such as Facebook, Twitter, LinkedIn and Myspace.

### SUMMARY OF THE INVENTION

The present invention is an online community-based knowledge verification system and method that facilitates knowledge verification for a virtually unlimited number of people regarding a virtually unlimited number of sources of informational content. The invention could also be embodied as a software system product that is used to provide a website environment hosted by one or more computer processing devices and databases. Such an embodiment can include one or more software components that may be distributed among, and executed by, a plurality of computer processing devices, including those that provide the hosting and database services, as well as personal information processing devices such as personal computers, smartphones, tablets and the like employed by users to access the website.

The invention provides community certification of an individual's knowledge of a particular source of informational content in the form of certificates that can be printed and shared electronically by the owners of those certificates. Community certification can be based upon a user correctly answering questions regarding the particular source of information.

“Crowd” certification can be granted when those questions to be correctly answered are established by qualified members of the community. The questions can be rated by qualified members of the community to determine each question's relative value in testing knowledge of the informational content. “Author” certification is granted when an author of the content source or medium establishes the questions to be answered correctly.

Members of the community are incentivized through, for example, monetary rewards or rewards of higher status, to provide questions for a particular source of content and to rate those questions. Over time, the number of questions available to establish crowd certification, as well as their value in properly testing that knowledge, increases. Authors of a particular source of content can be incentivized by the fact that it generates interest and discussion in the author's content.

Members are incentivized to become either crowd or author certified by issuance of certificates for each content medium that can be shared with other members of the knowledge verification community of the invention, as well as other community and social media sites, and potential employers.

In another aspect of the knowledge verification community of the invention, educators can use the site to provide customized online tests that are accessible by students over the Internet. Immediate feedback can be provided to the student, as well as statistical information regarding the class performance can be made available to the educator. In addition, organizations and private entities can use the invention to certify members and/or employees with regard to continuing education, specializations and required training.

In an embodiment of the invention, a system provides for an online community-based certification of a user's knowledge of content embodied in a content medium. The system includes a database for storing information descriptive of each of a plurality of content media and the content embodied therein. The information is stored at the request of one of a plurality of users belonging to the community.

The descriptive information for each content medium of the plurality of content media is associated with a unique content medium page. At least one computer processing device is coupled to the database, and the computer processing device is accessible to the users over a network. The system includes a question preparation engine, executed by the at least one processing device at the request of a user, to enable the requesting user to prepare test questions and associated answer options concerning the content embodied in at least one content medium of the plurality.

The system further includes a question judgment engine, executed by the at least one processing device at the request of a user, to enable the requesting user to assign an endorsement rating to questions prepared by other users through the question preparation engine for at least one content medium of the plurality.

The system also includes at least one certificate test engine, executed by the at least one processing device at the request of a user, to enable the requesting user to apply for a certificate for at least one content medium of the plurality for which a minimum number of questions and associated answer options have been prepared, the at least one certificate test engine granting ownership of the certificate for which the user applies if the user correctly answering a predetermined number of the prepared questions correctly.

In an embodiment of the system, execution of the question preparation engine, the question judgment engine and the at least one certificate test engine can each be initiated by a user by activating a link associated with a content medium page displayed on a user's personal processing device.

In another embodiment, the question preparation engine can be initiated by user claiming to be an author of the content embodied in the content medium to prepare author certification questions. In a further embodiment, the question preparation engine can be initiated by a non-author of the content embodied in the content medium to prepare crowd certification questions and answer options by which to test a user's knowledge of the content.

In another embodiment, the at least one certificate test engine includes an author certificate test engine that can be initiated by a user to apply for an author certificate, the author certificate test engine presenting one or more author certification questions and associated answer options to the user, the author certificate test engine granting the user ownership of the requested author certificate if the user correctly answers a predetermined number of the prepared author certification questions presented.

In yet another embodiment, the at least one certificate test engine includes a crowd certificate test engine that can be initiated by a user to apply for a crowd certificate, the crowd certificate test engine presenting one or more crowd certification questions and associated answer options to the user, the crowd certificate test engine granting the user ownership of the requested crowd certificate when the user correctly answers a predetermined number of the prepared crowd certification questions presented.

In another embodiment, each content medium page is stored in the database in association with a descriptor that is created from the information descriptive of the content medium and the content embedded therein, and an identifier unique to the content medium.

In an embodiment, the information descriptive of the content medium from which the descriptor is created is obtained from a source connected to the Internet in response to a search conducted by a user. In another embodiment, the information descriptive of the content medium from which the descriptor is created is obtained from information provided by a user using a form presented to the user through the user's browser.

In a further embodiment, for each content medium, the content medium page, the questions and associated answer options prepared by users through the question preparation engine, endorsement ratings provided for the prepared questions and answer options, and certificates granted by the at least one test certificate engine are stored in the database in association with the unique identifier for the content medium.

In other embodiments, the crowd certification questions and associated answer options presented by the crowd certificate test engine are those crowd certificate test questions having an endorsement score that exceeds a predetermined level.

In a further embodiment, the question preparation engine, the question judgment engine, and the at least one certificate test engine are initiated by a user from the content medium page by the user activating links that are displayed on the content medium page when it is displayed on the user's browser.

In yet another embodiment, a content medium page can be associated with a general topic rather than content embodied in a specific content medium, the questions and associated answer options prepared using the question preparation engine concerning the general topic being designed to test a user's knowledge concerning the topic generally.

In an embodiment, all certificates granted to a user through the at least one certificate test engine being displayed on a “Your Certificates” page displayed on the user's browser at the request of the user. In a further embodiment all certificates granted to a user through the at least one certificate test engine can be shared using a link unique to each granted certificate.

In yet another embodiment, the question preparation engine further includes author validation that stores an indication of validation for any prepared author certification questions and answer options prepared by a user alleging authorship of the content medium and stored in the database.

In an embodiment, each user is provided with a medium score for each content medium that is at least based on the number of questions the user has prepared for the content medium and the number of questions that the user has judged that were prepared by other users. In addition, each user is provided with a reputation score that is based on an average endorsement score attributed to all of the questions prepared for all content media by the user, as judged by other users.

In another embodiment, the question preparation engine is configured to issue a pre-certificate to at least one user for a content medium when an insufficient number of questions has been prepared by which a user's knowledge of the content embodied in the content medium can be sufficiently tested.

In a further embodiment, the at least one certificate test engine is configured to provide a user ownership of a granted certificate in exchange for either a predetermined payment or preparation of a predetermined number of test questions and associated answer options concerning the content embodied in the content medium for which the certificate is granted.

### BRIEF DESCRIPTION OF THE DRAWINGS

The following description can be better understood in light of Figures, in which:

FIG. 1 illustrates a simple representation of an embodiment of a site map including a homepage of the invention;

FIG. 2 illustrates an embodiment of a registered user's home page of the invention;

FIG. 3 illustrates an embodiment of a Content Medium Page of the invention for a book;

FIG. 4 illustrates an embodiment of a Your Certificates page of the invention;

FIG. 5 illustrates an embodiment of an actual Crowd Certificate of the invention;

FIG. 6 is a block-level diagram representation of an embodiment of the system of the invention;

FIG. 7 is an illustration of a functional flow carried out by system of the invention;

FIG. 8 is an illustration of a process flow performed by an embodiment of a Question Preparation Engine of the invention for non-Authors;

FIG. 9 is an illustration of a process flow performed by an embodiment of a Question Preparation Engine of the invention for Authors;

FIG. 10 is an illustration of a process flow performed by an embodiment of a Question Judgment Engine of the invention;

FIG. 11 is an illustration of a process flow performed by an embodiment of an Author Certificate Test Engine of the invention;

FIG. 12 is an illustration of a process flow performed by an embodiment of a Crowd Certificate Test Engine of the invention.

### DETAILED DESCRIPTION

The present invention is an online knowledge verification system, method and software system product that provides community-based knowledge certification. In an embodiment, the system can be provided as a hosted website that is accessible over the Internet by members of the general public who are willing to register with the website. In other embodiments, the invention can also be employed to provide knowledge certification for more limited groups such as employees of a corporation or members of an association, through private networks or virtual private networks (VPNs) that are only accessible to those certain individuals to whom access has been granted.

The website can be hosted by a web hosting service as is well known in the art, and is typically stored in non-transitory memory in association with one or more computer processing devices such as servers. The one or more servers access the non-transitory memory for some or all of the software components necessary for carrying out the method of the invention. The one or more servers may further include one or more processing devices for retrieving from the non-transitory memory the software instructions of those software components, and for executing the retrieved instructions necessary to carry out the method of the invention. The one or more servers can also be supported by one or more databases stored on the non-transitory memory media, to and from which data necessary for operation and maintenance of the hosted website of the invention can be stored and retrieved respectively.

The website of the invention can be accessed through a network such as the Internet, by remote users using any number of possible personal processing devices such as Personal Data Assistants (PDAs), smart phones, desktop and laptop computers, tablets and the like. It will be appreciated by those of skill in the art that these devices also include non-transitory memory media for storing software and one or more processing devices for retrieving and executing the instructions of the software.

The method of the invention can be carried out by the hosting computers and database systems through execution of some or all of the software components of the software system product, in response to commands transmitted from personal processing devices as described above. The commands can be provided by standard browser software stored on and executed by the personal processing devices, or by way of application software components that can be downloaded from the hosted site or from some other application software providers to the personal processing devices of users.

Thus, it will be appreciated by those of skill in the art that the software system product of the invention can be distributed as cooperative software components among, and are therefore executed by, a number of processing devices. Thus the various software product components taken together are configured in the form of a software system product. It will also be appreciated that the various components of the software system are stored in the non-transitory memory media associated with processor devices used to access and execute the software as instructions from the memory media. The execution of those instructions by the one or more processors taken together, thereby carry out the method of the invention.

The present invention is able to provide knowledge verification through certification for virtually any specific content source (or medium) that can be either identified over the Internet or that can be identified and submitted by a user of the website. Typical content media can be books, documents, films, other websites, course materials, published or unpublished papers, manuals, protocols and the like. The content source database and the certification of the knowledge of the content is self-generated by the community as the community members access and use the invention. The content media are identified by users of the invention, either by searching the Internet for specified content media, for listings of content media by topic, or by introducing the content to the community themselves.

Certification can also be provided for a generalized topic, where the certification can be based upon certification for any number of content media that falls under such as general topic, or through testing based on questions authored to demonstrate knowledge of the general topic without reference to or association with, any specific medium.

The questions for certifying the knowledge of the content can be proffered by members of the community, authors of the content and possibly even by educators. The questions used for certification are rated by members of the community as to their effectiveness in the testing and verifying of the acquired knowledge regarding the content. In this way, the less effective questions may be culled in favor of those judged by members to be more effective.

Those of skill in the art will appreciate that members of the public can be registered as users of the website to join the community and such registration techniques are well known in the art. Typically, a user registers by providing personal identification information, a username and a password that permits the user to login to the website. For embodiments of the invention implemented on private networks and VPNs, those of skill in the art will appreciate that a user is given private access information from the network owner to restrict access to only those individuals authorized to have access. Those of skill in the art will further appreciate that the user profile can be expanded to include information regarding a user's education, personal interests and status in the community. For example, the user's profile can be updated with information regarding the number of certificates attained and the topics that characterize the content of those certificates.

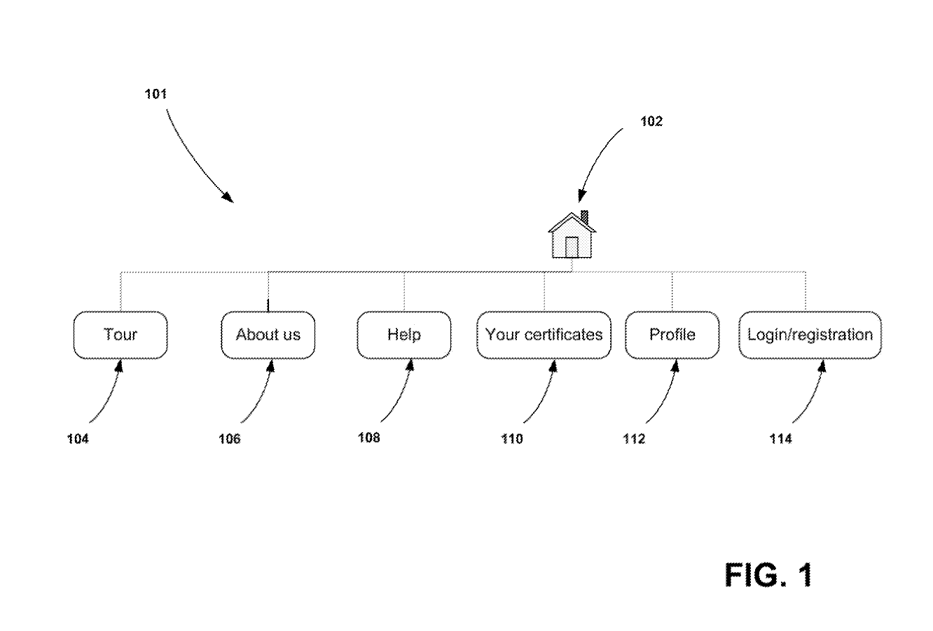

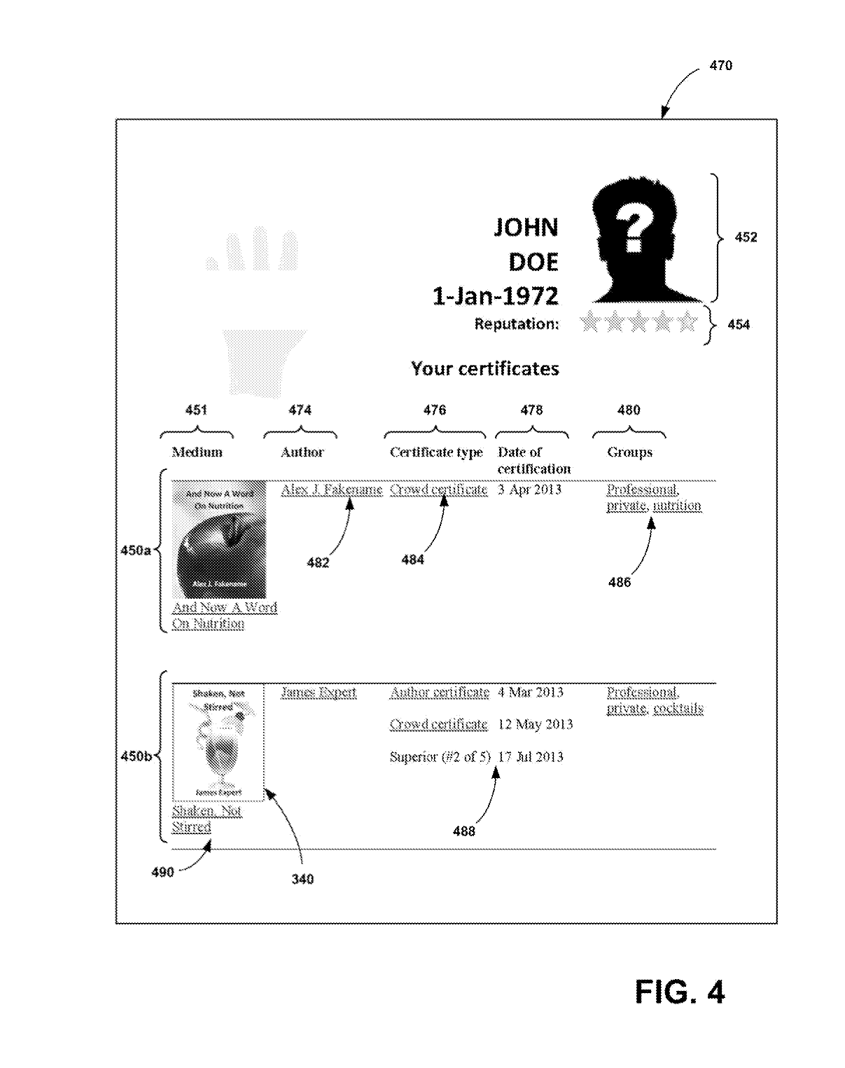

FIG. 1 illustrates a simple representation of an embodiment of a site map 101 including a homepage 102 of the invention. Clicking on button 114 allows a registered user to login to the website of the invention, or to register to become a user of the site and to thereby become a member of the community. Activating button 104 links a user or potential user to a tour of the site. Activating button 106 links a user or potential user to information regarding the community. Activating button 108 links a user or potential user to help information. Activating button 110 links a “logged-in” user to that user's Your Certificates page (470, FIG. 4), where the user can display certificates earned by that user and to access pertinent information regarding the user's certificates. Activating button 112 links a registered user to the user's profile for review and editing.

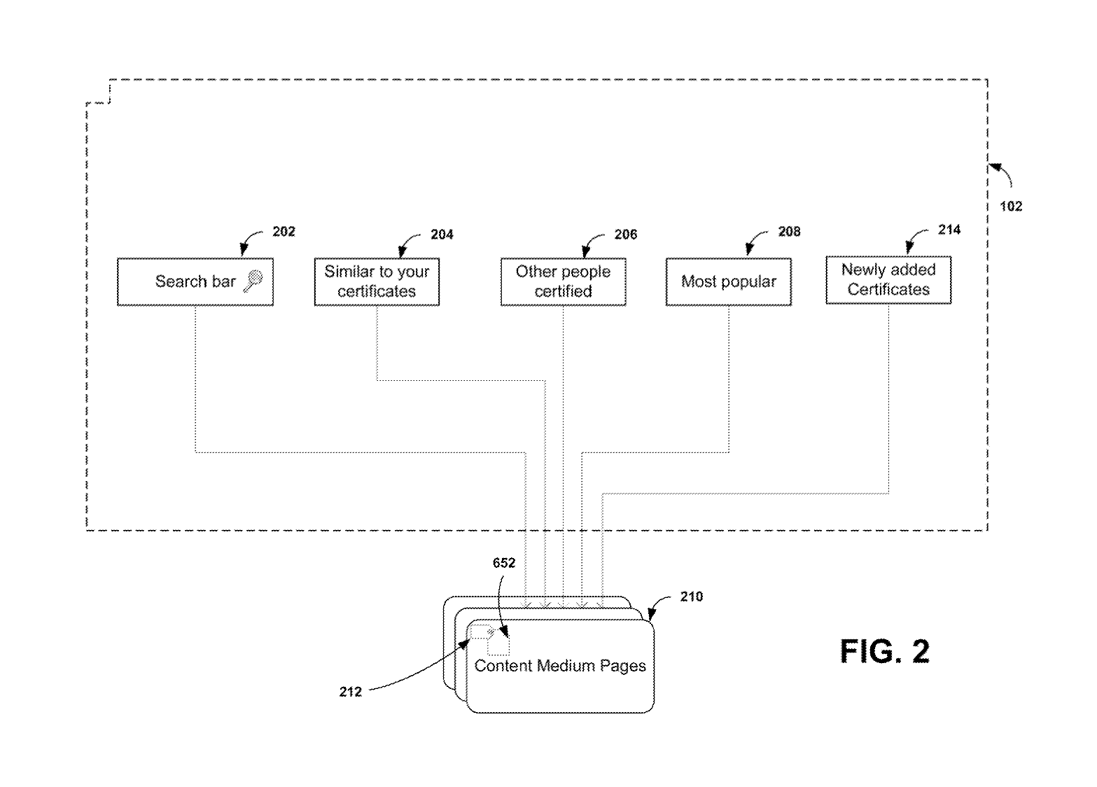

FIG. 2 illustrates an embodiment of a registered user's home page 101, on which links are provided to Content Medium Pages 210 that are stored in the community database (not shown). In an embodiment, “search bar” 202, and buttons 204, 206, 208 and 214 provide links to the Content Medium Pages 210 stored in the community database. Search bar 202 allows a user to search the database for content media that are related to search topics or actual content media by title, ISBN, author or publisher. A list of content media that are compatible with the search term can be returned. Clicking on or activating items in the list redirects the user's browser to the medium page for that particular content medium. Each of the listed items can be represented as text title listing, or they can be thumbnails of the covers or other identifying visual media associated with the content medium.

It should be noted that the search bar 202 can be linked to external sites that specialize in content media such as Amazon, Barnes and Noble, etc. This can be accomplished through an interface program such as an application program interface (API). This allows the identification and introduction into the system of content media that may not currently have a Content Medium Page 202 already stored in the community's database.

Activating the “Similar to Your Certificates” link 204 can show content media that are similar to media for which test questions have been answered by the user in the past. The “Other People Certified” link 206 can be activated to show content media that are certified to other users who share a certification with the user. The “Most Popular” link 208 can show those content media that have seen the most activity in the community for some period of time, such as during the current week. The “Newly Available Certificates” link 214 can show those content media for which certificates have recently been added. The “Your Certificates” 110 link that is illustrated in FIG. 1 can take the user to a “Your Certificates” page (470, FIG. 4) that shows a listing of a number of a user's most recent certificates as thumbnails. Clicking a link to one of them can redirect a user to the Content Medium Page 210, FIG. 2 associated with that certificate.

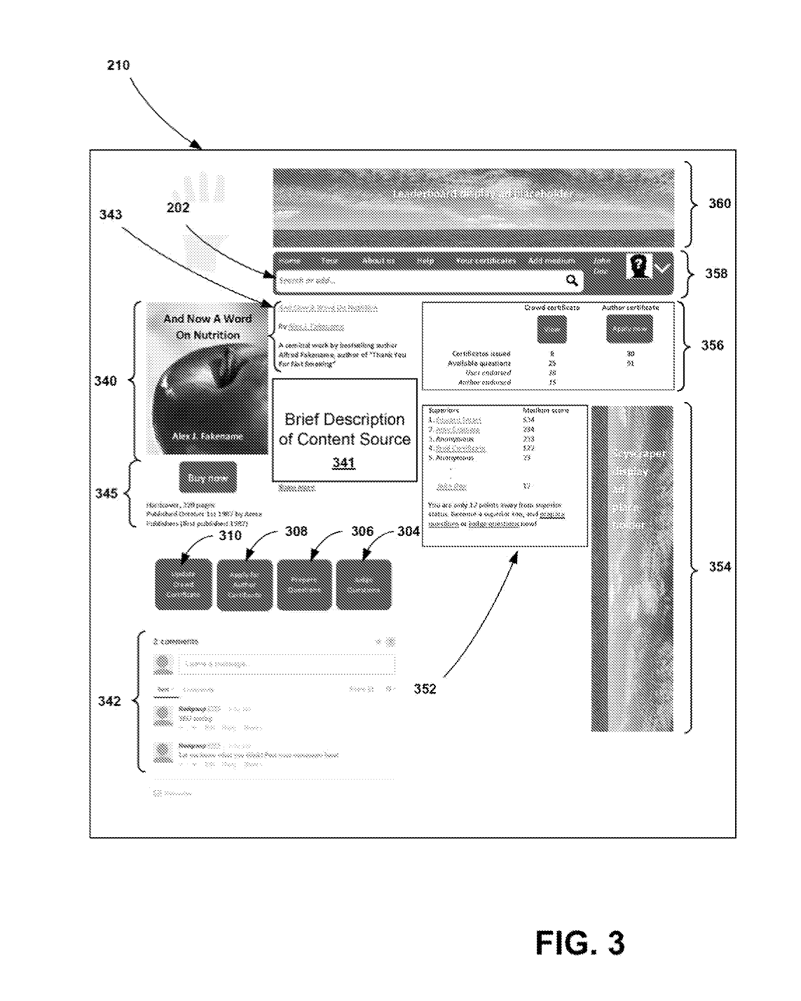

FIG. 3 illustrates an embodiment of a Content Medium Page 210 for a book. Content Medium Page 210 can be configured to include an image 340 (e.g. a thumbnail image) of the cover of the book and adjacent to it, standard information about the book 343 such as the publisher, the author, the ISBN (international standard book number), and a short description of the book below 341.

In addition, community statistics 356 can be provided, such as the current number of certificates and their type (e.g. Author or Crowd) that have been issued for the book. The types of certificates of the invention that can be issued will be more specifically discussed below. In addition, the total number of available certification questions about the book can be included. These questions can include both user endorsed and author endorsed questions. User endorsed questions can be questions that meet a certain minimum level of endorsement from all of the users who have judged the questions. For example, an endorsement score for a particular question can be determined by the median of the endorsement ratings supplied by all users that have judged this particular question on a scale of one to ten where ten is the highest level of endorsement. In this case, only questions that have achieved a median endorsement score of six are retained. This can also be further gated by requiring a minimum of three endorsement ratings to be submitted for a given question. Author endorsed questions can indicate that the author of the content endorsed the question with a passing rating.

The community statistics 356 for the selected and displayed Content Medium page 210 can also include data that is pertinent to the user, such as links to any certificates owned for this content medium (if any) by the user, and the user's current score regarding the content medium (i.e. the “Medium Score”). A user's Medium Score can be determined from a number of criteria including the sum of: the user's “Endorsement Score” (i.e. how others rated the user's questions for the content medium, for example, on a scale of one to ten), the user's “Question Score” (i.e. how many questions the user has prepared for this content medium), the user's “Early Bird Score” if any (e.g. the first five users for a content medium can receive extra points), and the user's “Endorsement Score,” awarded for the number of questions prepared by other users that the user has judged. Information regarding other users may also be included in text box 352, such as those with the highest Medium Score. Because they are the most highly rated in their contribution to the community for this content medium, they can be recognized for that accomplishment with a special designation, such as referring to them as “a Superior.” The Medium Score of each Superior can be reported next to their name.

Navigation bar 358 of Content Medium Page 210 includes a number of links previously discussed, including search bar 202, and Your Certificates link 110, FIG. 1. A comment section 342 can also be provided that provides an opportunity for users to contribute commentary regarding the particular content medium, as is known in the art. In addition, web advertising links such as blocks 360 and 354 can be included for revenue generating purposes. A link 345 can also be provided by which a user can purchase a copy of the content medium from a retail source through a direct link to an ecommerce website accessed over the Internet.

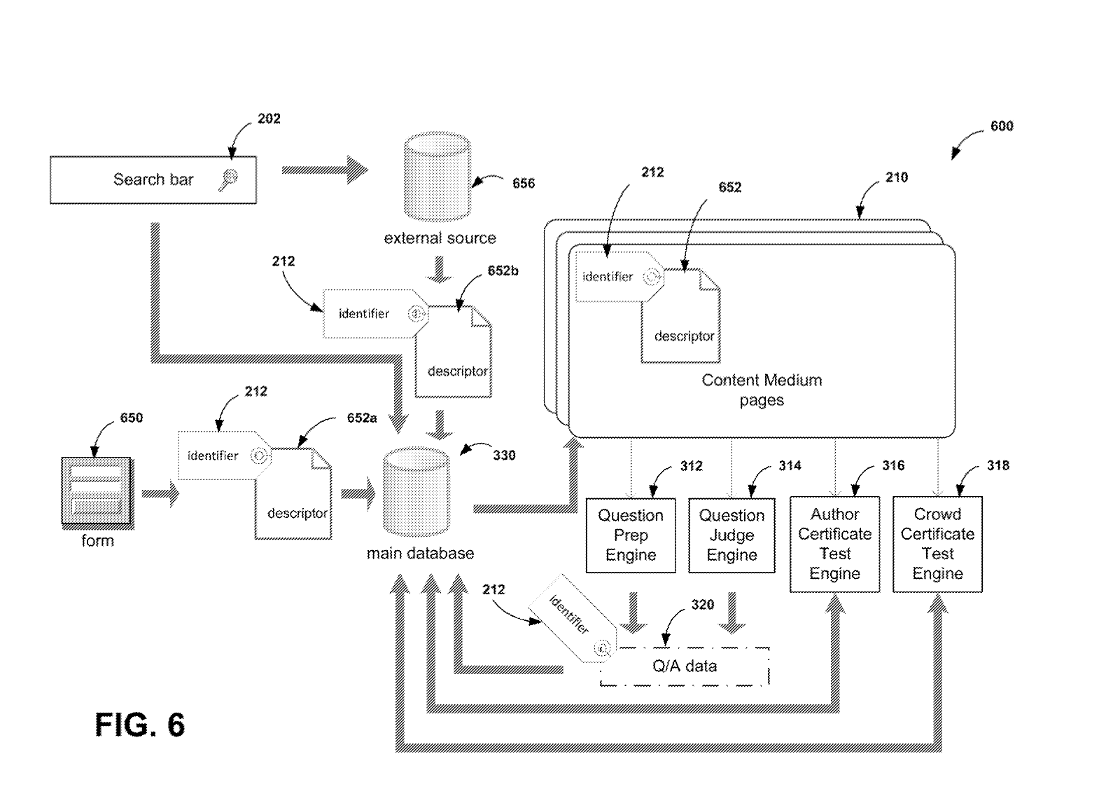

Activating the button link 310 for “Update Crowd Certificate” launches a Crowd Certificate Test Engine that permits a user to correctly answer questions to update the user's Crowd Certificate issue date to the current date to, for example, prevent the user's certification from becoming stale. The Crowd Certificate Testing Engine 318 will be discussed in more detail below with reference to FIGS. 6, 7 and 12. It should be noted that button link 310 appears to the current user as “Update Crowd Certificate” because the user already has a Crowd Certificate for this Content Medium Page 210. If the user did not already own a Crowd Certificate, the button link 310 would appear to the user as “Apply for Crowd Certificate” instead.

Activating the link 308 for “Apply for Author Certificate” launches an Author Certificate Test Engine 316 that permits a user to correctly answer questions to obtain ownership of an Author Certificate for the content medium associated with the current Content Medium Page 210. The Author Certificate Test Engine 316 will be discussed in more detail below with reference to FIGS. 6, 7 and 11.

Activating the link 306 for “Prepare Questions” launches a Question Preparation Engine 312 that permits a user to prepare questions for use in certifying other users for the content medium associated with the current Content Medium Page 210. The Question Preparation Engine 312 will be discussed in more detail below with reference to FIGS. 6, 7, 8 and 9.

Activating the link 304 for “Judge Questions” launches a Question Judgment Engine 314 that permits a user to judge questions prepared by others for use in certifying other users for the content medium associated with the current Content Medium Page 210. The prepare Question Judgment Engine 314 will be discussed in more detail below with reference to FIGS. 6, 7 and 10.

As previously discussed, activating the Your Certificates link 110 of navigation bar 358 will take a user to a Your Certificates page (470, FIG. 4) for that user that provides a listing of all of a user's certificates. An embodiment of a Your Certificates page 470 is illustrated in FIG. 4. Profile information 452 can be provided that can include a profile picture or avatar, as well as name and date of birth.

Users can also be given a “Reputation Score” 454 that is representative of how those in the community rate or judge a user's overall contributions to the community. For example, a user's Reputation Score can be based upon judgment values provided by other users with respect to all questions prepared by user, spanning all content media for which the user has prepared questions. Those of skill in the art will appreciate that other factors can be used to establish a Reputation Score, including an average Endorsement Score for all of the user's submitted questions as rated by other users, (as discussed above), the total number of certificates owned by the user, a user's average Medium Score for all certificates owned by the user, and the total number of certificates that were initiated by the user.

It should be noted that a user's Medium Score is intended to be for a particular content medium or topic, whereas a user's Reputation Score spans the user's judged value as attributed to the user by the community, over all content media and topics to which the user has contributed.

Each of the user's certificates 450a and 450b are listed on Your Certificates page 470. Each listing includes information identifying the content medium 451, such as thumbnail 340 and Title 490. Thumbnail 340 and title 490 can also be links, such as to more detailed information regarding the content medium, to more content similar to the identified content medium or to the certificate itself. Each listing can further include the author name 474, which can be a link 482 to other content created by that author, a certificate type 476 that provides a link 484 to the actual certificate, a certification date 478 and “groups” information 480 that indicates groups of users or topics associated with the content medium, and links thereto 486. Certificate type information 476 can also include additional information, such as whether the user has achieved the status of Superior and the date 488 when the status was achieved.

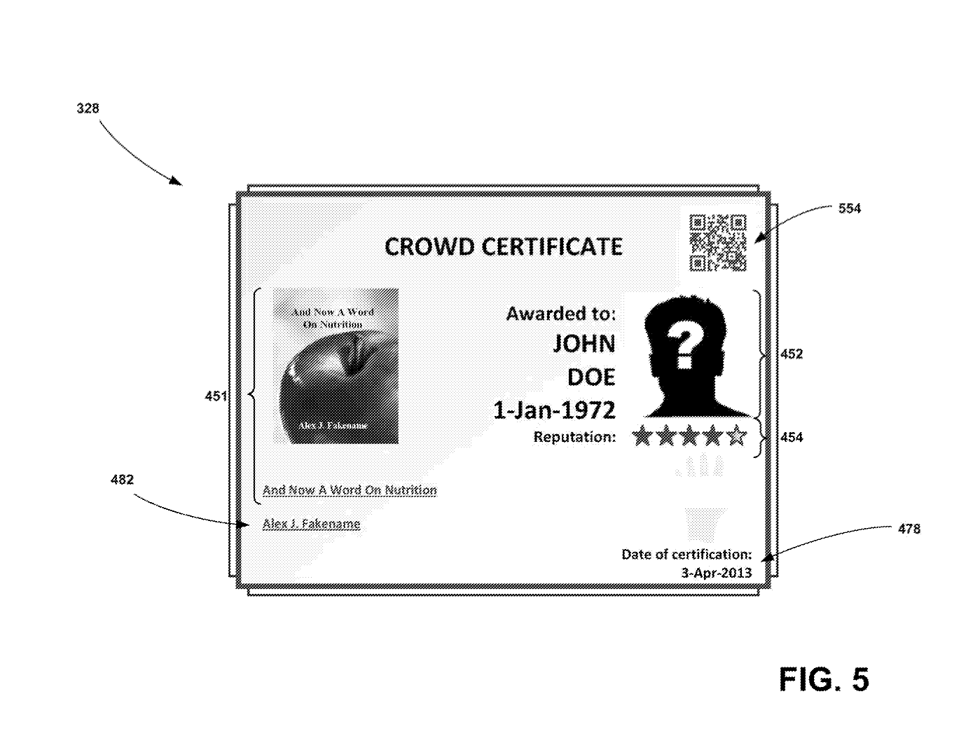

Activating a link to one of the listed certificates such as through link 484 will navigate the user to the actual certificate. An embodiment of an actual certificate is illustrated by Crowd Certificate 328 of FIG. 5. From this page, links that allow the user to print the certificate, share the link information with others through email or on social media websites can be provided but are not shown. A certificate such as Crowd Certificate 328 can include the user profile information 452 and user reputation score 454 from the Your Certificates page 470 as discussed above. Medium information 451, author name 482 and certification date 478 are also provided. A quick response bar code 554 can also be provided that can be used to encode the URL link address of the certificate to facilitate sharing of the certificate with others as is known in the art.

FIG. 6 is a block-level diagram representation of an embodiment of the system of the invention. As previously discussed, if a user wishes to become certified for a certain content medium such as a book, the user can enter search terms in search bar 202 that can be used to determine whether the content medium is already in system 600. The search terms can be topic based, which might produce a list of a number of content media that are related to that topic from which the user can choose. This can be useful for a user that is interested in browsing a topic, and is not yet looking for a specific content medium that is related to the topic of interest. The search terms can also be more specific to a particular content medium.

System 600 can first search main database 330 to see if the desired content medium already has a Content Medium Page 210 stored therein. If yes, the Content Medium Page 210 is delivered to the user's browser. If not, the search can be directed outside of system 600 to other website locations on the Internet that are making the content medium publicly available. For example, the database 656 for some online medium retailer may be accessed for publically available information regarding the content medium, referred to herein as descriptor information. This descriptor information, such as author name, publisher, ISBN and descriptive information such as a thumbnail picture of the cover can be retrieved from the website database 656.

System 600 is configured to glean this information from the file retrieved from the remote database and can then be used to create a descriptor file 652. The descriptor file 652 is associated with a system identifier 212 that uniquely identifies this particular content medium within system 600, and the descriptor file 652 with attached identifier 212 is then stored in main database 330 of system 600. The user's browser can then be presented with a Content Medium Page 210 (such as the embodiment of a Content Medium Page 210 illustrated in FIG. 3) that is also tagged with identifier 212 and that incorporates and presents the descriptor information 652 as illustrated in FIG. 3. A link (345, FIG. 3) can also be provided on Content Medium Page 210 through which the user can navigate to the remote website to purchase the content medium itself. Those of skill in the art will recognize that identifier 212 can be any means by which data in a database can be relationally tagged and uniquely identified among several separate files, such as a unique numeric or alphanumeric string.

Those of skill in the art will recognize that any data that is unique to the user, such as the user's certificates, questions prepared, Endorsement Scores, Medium Scores, and Status are all stored in database 330 of system 600 in association with a user identifier that permits easy updating, access and retrieval of all such information that is unique to that user for purposes of displaying that information on the pages disclosed above when that user is logged into the system.

If a Content Medium Page 210 does not already exist in database 330 for a content medium for which a user wishes to become certified, and the requisite information for creating a descriptor file 652 for that content medium is not publicly available over a network such as the Internet, the user can introduce the requisite information for creating a descriptor file 652 by filling out a form 650 right from the user's browser. Thus, system 600 is configured to create and tag a descriptor file 652 for a content medium regardless of the source (e.g. Internet or user supplied) of the descriptor information.

Once a Content Medium Page 210 is created for a content medium, a user can access that Content Medium Page 210, and then invoke a number of system processes from that Content Medium Page 210. A user can invoke the Question Preparation Engine 312, which takes the user a through a process by which the user can prepare certification test questions and correct answers. This question and answer data 320 is then tagged with identifier 212 and stored in the main database 330. A user can invoke the Question Judgment Engine 314, through which the user is able to judge the value of certification test questions prepared for the content medium by other users. The Endorsement Score data for those questions is tagged with identifier 212 and is stored in main database 330. A user can invoke Author Certificate Test Engine 316 by which the user can receive an Author Certificate by correctly answering a predetermined number or percentage of questions prepared by an author of the content medium. Questions are retrieved from database 330 and the results of the test are stored in database 330. Finally, a user can invoke the Crowd Certificate Test Engine 318 by which the user can receive a Crowd Certificate by correctly answering a predetermined number or percentage of questions prepared by an author of the content medium.

It should also be pointed out that a Content Medium Page 210 can be created for a general topic as well. Although the Content Medium Page 220 would not be associated with any specific content or content medium, questions can be prepared by users of the system, those questions can be judged, and testing of knowledge of the topic can be used to certify users with a Crowd Certificate just as with a specific content medium. The system of the invention can also be used by educators to administer examinations and quizzes online regarding specific content media as well as topics as described above. When used in this way, immediate feedback is provided to both the student as well as the educator regarding each student's performance. Of course in this case, access to the topic or Content Medium Pages could be restricted to only students of the class and the educator. This is also true for certification courses unique to a specific employer or organization, where for example employees or members of a professional association are being tested for compliance with continuing education requirements or safety procedure training on new equipment for example.

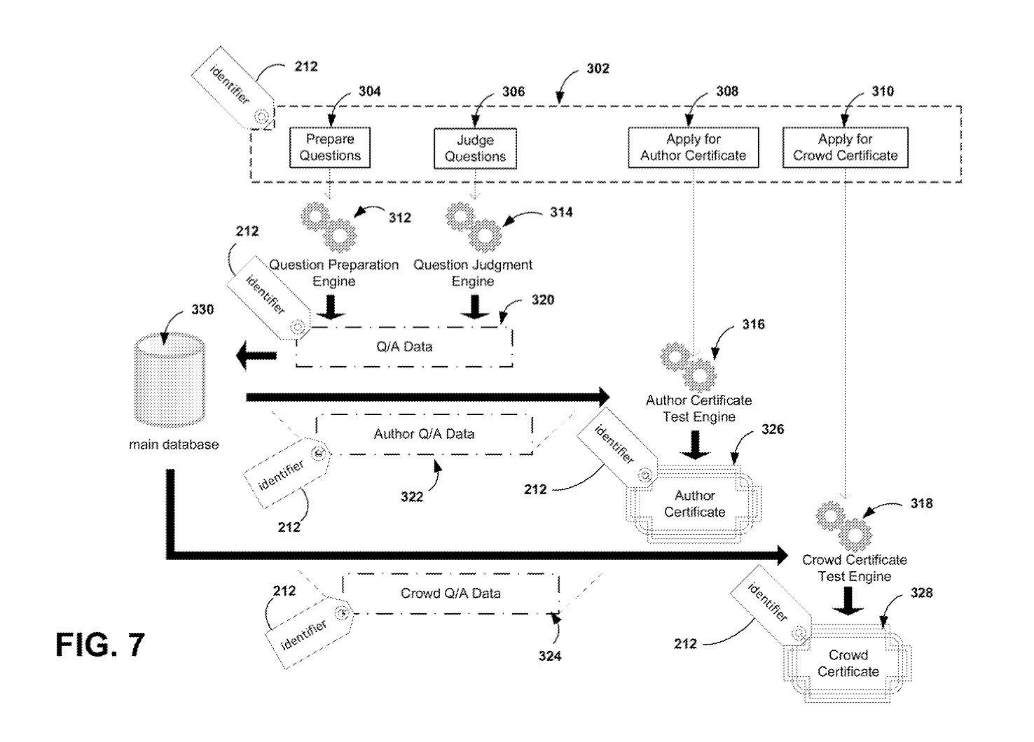

FIG. 7 illustrates the functional flow carried out by system 600 initiated by a user's activation of each of the link buttons 304, 306, 308 and 310 located on a Content Medium Page (210, FIG. 3) as previously discussed above. Activating link button Prepare Questions 304 calls the Prepare Questions Engine 312. A user can invoke this process when the user wishes to contribute questions and answers for purposes of testing other users in their knowledge of the content provided by the content medium or general knowledge of a topic associated with Content Medium Page 210. A user can be the first one to prepare questions. This might even occur when a user wishes to be certified regarding a content medium or topic not previously established by another user in the system 600.

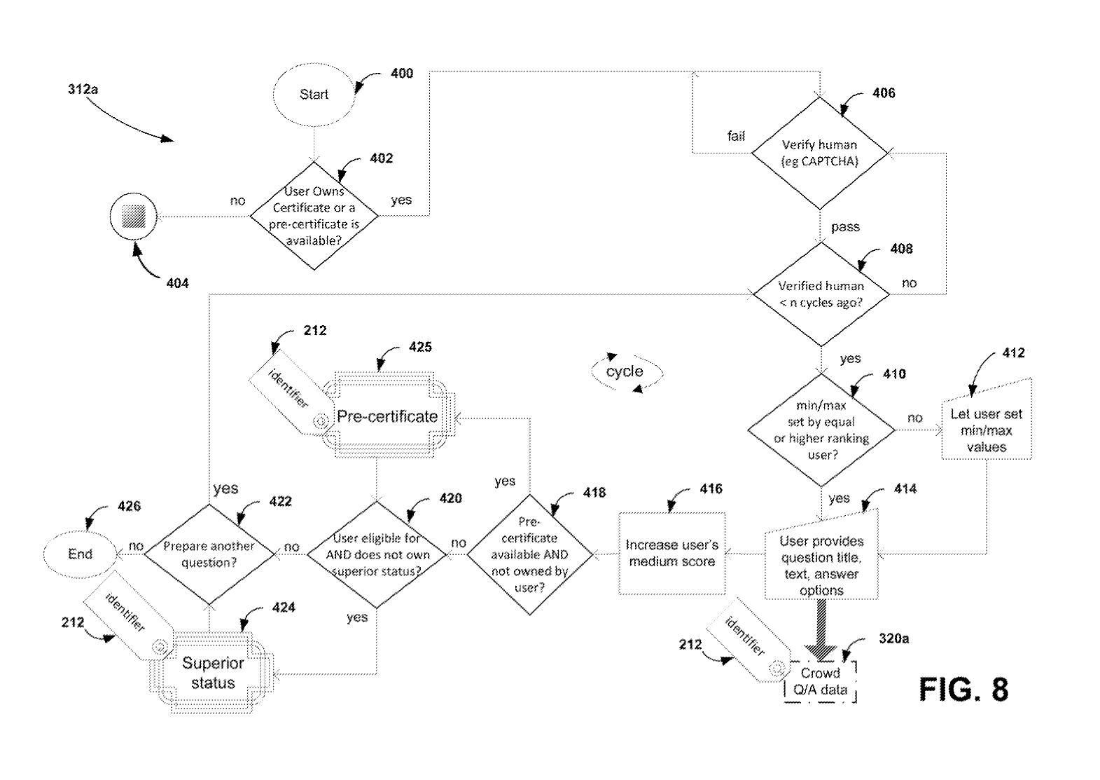

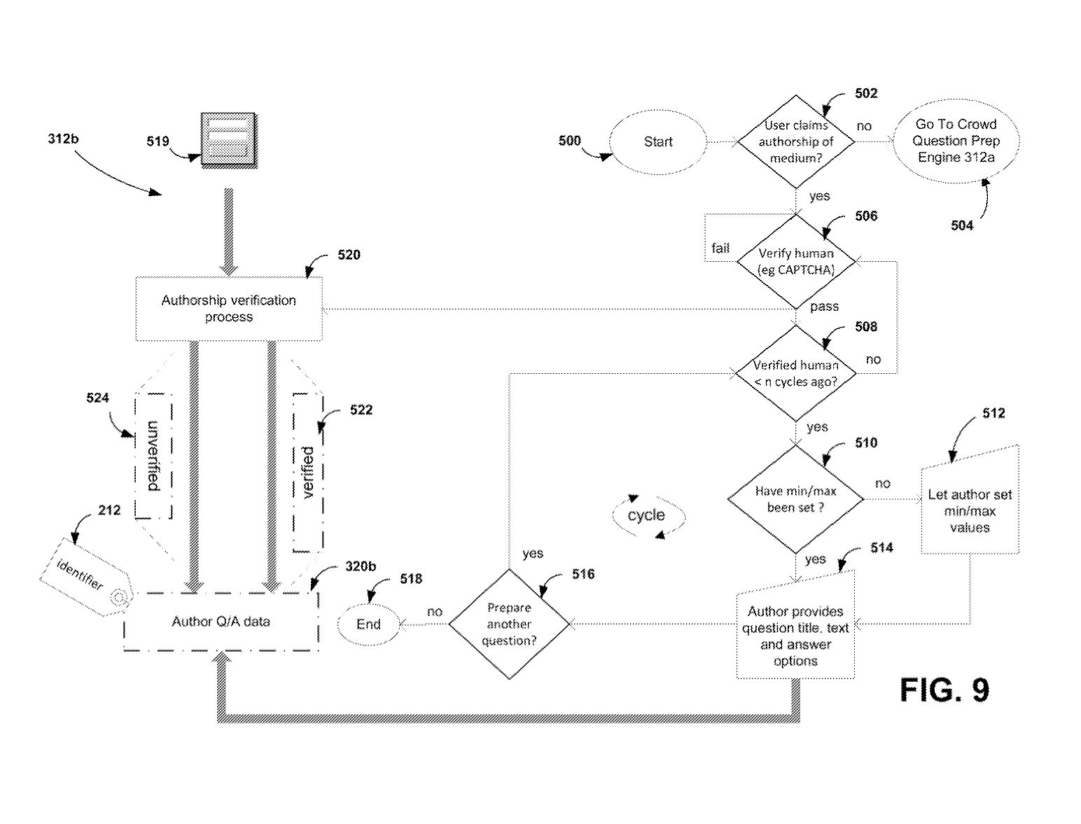

The process flow performed by the Question Preparation Engine 312 will now be discussed in view of FIG. 8 and FIG. 9. A user can initiate the Question Preparation Engine as either a crowd user 312a or as an author 312b of the content of the content medium. FIG. 8 illustrates the procedural flow of the Question Preparation Engine 312a for questions prepared by crowd users for content or topics provided with the Content Medium Page 210 from which the engine is launched as previously discussed.

The process starts at 400 when the user activates the prepare questions button link 304 as it appears on the Content Medium Page 210. Processing continues at decision block 402 where it is first determined if a Crowd Certificate is currently owned by the user for the content or topic associated with the Content Medium Page 210 from which the process was launched. If not, then it is determined if a Pre-certificate is available for this content or topic. A Pre-certificate is one that can be awarded to a limited number of users who first seek certification for the topic or content associated with the Content Medium Page 210. This incentivizes users to initiate certification for new content or topics BEFORE there are sufficient questions prepared by which to be certified through a Crowd Certificate for example. If the answer to both of these questions is NO, the user is not allowed to prepare questions until the user has become certified with a Crowd or Author Certificate for the topic or content. Flow proceeds to 404 where the button link 304 on the Content Medium Page 210 is deactivated, and the process ends.

If the answer at decision block 402 is YES, then processing continues at decision block 406 where it is determined whether the user is in fact a human user and not an automated machine. Any known technique, such as CAPTCHA (“Completely Automated Public Turing test to tell Computers and Humans Apart”), that protects websites against robot machines such as Spambots and automated hacker programs by generating and grading tests that humans can pass but current computer programs cannot, can be employed. If the test fails, it is repeated until it passes and processing flows to decision block 408, which determines how many cycles of the process have been executed and when that number exceeds some predetermined number n, processing returns once again to block 404 where the test is administered once again. Those of skill in the art will recognize that this is a fail-safe in the event that a machine makes it past the test the first time.

If the number of cycles is less than n, processing continues at decision block 410 where it is determined whether the minimum and maximum number of questions has been set already by a previous user having a higher rank than the current user. This ranking can be determined by the overall Content Medium scores of the users, or other objective means of ranking such as the Reputation scores of the users, or a combination thereof. If the answer is NO, then processing continues at 412 where the user is permitted to establish the minimum and maximum numbers of questions for crowd certification and processing continues at block 414. If the answer at decision block 410 was YES, then process also continues at block 414.

At block 414, the user provides a question title, question text and answer options. Those of skill in the art will appreciate that multiple choice or true/false type questions are the easiest to employ, as they are the easiest to determine if answered correctly in an automated manner. Notwithstanding, the present invention is not limited to the foregoing, and techniques by which essay style questions and answers could be automatically graded, or by which users might be employed to grade essay answers are also envisioned to be within the scope of the present invention. The resulting prepared question and answer crowd data 320a is then tagged with identifier information 212 and stored in main database 330 as illustrated in FIG. 7.

Processing continues at block 416, where the user's content medium score for the topic or content associated with the Content Medium Page 210 from which Question Preparation Engine 312a was launched is increased. Those of skill in the art will recognize that increasing the user's score for the user's contribution to the community incentivizes the user to make such contributions for the benefit of the community.

Processing continues at decision block 418, where it is determined whether a Pre-certificate is still available for this content or topic, and if so, whether the user does not currently own one already. If the answer is YES to both questions, a Pre-certificate is awarded to the user, and the identifier information for the topic or content associated with the current Content Medium Page 210 is attached to this Pre-certificate and it is also stored in the main database 330 of system 600. If the answer to either question at decision block 418 is NO, processing continues at decision block 420 where it is determined if the user qualifies for or does not already own Superior status for the content or topic associated with the current Content Medium Page 210. If the answer to both questions is YES, processing continues at block 424 where Superior status is awarded to the user, and the information regarding the user's Superior status along with the identifier tag 212 is stored in database 330 of system 600.

If the answer is NO to either question at decision block 420, or if Pre-certification is awarded as described above, processing continues at decision block 422 where it is determined whether the user wishes to prepare and submit another question. If the answer is NO, the process ends at 426. If the answer is YES, processing returns to decision block 408 to determine if n cycles of the process have occurred since the last time the user was verified as human. If NO, processing continues at decision block 410 and repeats as previously described. If the answer is YES, processing returns to block 406 and re-verification of the user as human occurs before processing continues as previously described from that point.

FIG. 9 illustrates the procedural flow of the Question Preparation Engine 312b for questions prepared by authors of content provided by a content medium. In an embodiment, when a user viewing a Content Medium Page 210 for which authorship has not been previously claimed by an author of the content, if the user has the same surname as an author surname listed for the content medium, the user can be prompted to claim authorship of the content. In an embodiment, the user can be prompted by converting the “Apply for Author Certificate” link button (308, FIG. 3) to a “Claim Authorship” link button for that user as the user views the Content Medium Page 210 for that medium. In the absence of an available Author Certificate, the “Apply for Author Certificate” button 308 can be rendered unclickable to all other users who do not have the same surname as an author surname listed for the content medium.

If the user decides to claim authorship by clicking on the Claim Authorship button, a verification process is initiated that can include prompting the user for personal information such as, but not limited, the user's social security number or other credentials capable of identifying the user as an author of the content associated with the Content Medium Page 210. This information can be entered to the system through form 519, which can be displayed to the user after the Claim Authorship button has been activated. Data entered into form 519 is presented as input to an authorship verification process 520.

Those of skill in the art will recognize that the verification process 520 can be performed online in real time, or offline over a longer timeframe. Once authorship is claimed by the user, the user is able to prepare questions and their answers for the purposes of certifying other users with an Author Certificate. The user claiming authorship is able to enter this process by activating link button Prepare Questions 304 by clicking on it. A user having activated that button will initiate Question Preparation Engine 312b starting at 500. Processing begins at decision block 502, where it is determined if the user is claiming authorship. If the answer is NO, processing is directed to the Crowd component 312a of Question Preparation Engine 312.

If the answer is YES at block 502, processing continues at decision block 506. Decision blocks 506 and 508 perform the same process as decision blocks 406 and 408 as previously described with reference to Crowd component 312a of Question Preparation Engine 312 in FIG. 8. They are configured to verify that the user invoking the Author component 312b of Question Preparation Engine 312 is a human and not a machine.

If the user passes the test and has not reached n cycles of the question authoring process of the Author component 312b of Question Preparation Engine 312, processing continues at decision block 510, where it is determined whether a minimum and maximum number of questions has been set by a user claiming authorship. If the answer is NO, the user claiming authorship is permitted to set that those minimum and maximum numbers at block 512 before processing resumes at block 514. If the answer is YES, processing also continues directly at block 514, where the user claiming authorship provides Author Question and Answer Data 320b in the form of a question title, question text and answer options. The Author Question and Answer Data 320b is tagged with identifier 212 and is then stored in main database 330, FIG. 7.

If the author verification process 520 has been successfully completed for the user, the Author Question and Answer Data 320b is provided with a notation 522 that the Author has been verified and the Author Question and Answer Data 320b can be used for testing other users in qualifying then for an Author Certificate. If the author verification process 520 has not been completed, the Author Question and Answer Data 320b is provided with a notation 524 that the Author Question and Answer Data 320b is for the moment unverified and thus should not be used or presented to a user for Author Certificate testing, at least until the Author has been verified.

Processing continues at decision block 516 where it is determined whether the user claiming authorship wishes to prepare another question. If the answer is NO, processing ends at 518. If the answer is YES, processing returns to decision block 508 where it is determined whether n cycles of the question preparation process have been repeated. If NO, processing continues as previously described. If the answer is YES, then processing goes back through the human/machine test as previously described and n is reset back equal to zero. Processing then continues as previously described.

It should be noted that until a user claiming authorship has been verified for their surname, any user with that surname can claim authorship and invoke the Author component 312b of Question Preparation Engine 312. All Author Question and Answer Data 320b is marked as unverified until verification is complete. Any Author Question and Answer Data 320b that has been submitted by a user that is not the verified user can be deleted from database 330. Furthermore, once a user has been verified as an author of the content medium for that surname, no other users having the same surname will be prompted in the future as previously described. It should also be noted that a content medium having more than one author can verify all authors for that content medium, even after one or more of the co-authors have been verified as previously described.

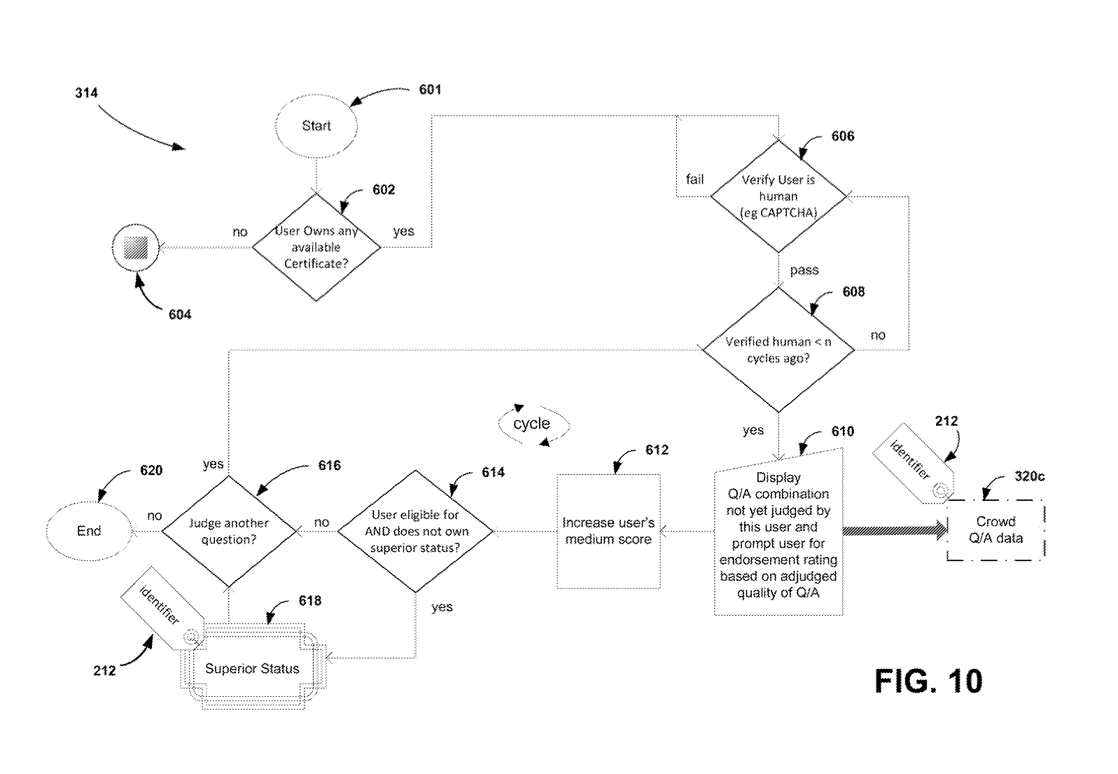

A user viewing a Content Medium Page 210 can also invoke the Question Judgment Engine 314, which is illustrated by the procedural flow diagram of FIG. 10. A user activates the Question Judgment Engine 314 by activating the Judge Questions link button 306 as presented on Content Medium Page 210, as illustrated in FIG. 3 and FIG. 7. Processing begins at 601, and proceeds to decision block 602, where it is determined whether the user owns any available certificate (e.g. a Pre-certificate, an Author Certificate or a Crowd certificate), for the content medium or topic associated with the Content Medium Page from which engine 314 was invoked. If the answer to this question is NO, the Judge Questions link button 304 is deactivated on the Content Medium Page 210 as viewed by the user and processing ends at 604, as a user that does not own a certificate for a content medium or topic for which one is available, is not permitted to judge questions for that medium or topic.

If the answer to the question at decision block 602 is YES, then processing continues through blocks 606 and 608 where the user is verified to be human over machine as previously presented in more detail above in the presentation of the Question Preparation Engine 312 and with reference to FIG. 8. Provided the user passes the test, processing continues at block 610, where the user is presented with a question and associated answers that has not yet been judged by the user, and is prompted for an endorsement rating that is entered by the user based on the user's adjudged value of the question and answers. As previously discussed, those of skill in the art will recognize that endorsement ratings can be based on any number of well-known scoring techniques, such as on scale of 1 to 10.

After the user enters a endorsement rating for that question and answer data, the judgment data 320c is tagged with identifier 212 and stored in main database 330 with the Crowd Question and Answer data 320, and processing continues at block 612, where the user's content medium score is increased as an incentive for judging the question. Processing then continues at decision block 614, where it is determined whether the user is eligible for Superior Status for the topic or content medium associated with the current Content Medium Page 210 and further that the user does not already own Superior Status. If the answer to both questions is YES, processing continues at block 618 where Superior Status is awarded to the user, after which processing continues at decision block 616.

If the answer to either question at decision block 614 is YES, processing also continues at decision block 616, where it is determined whether the user wishes to judge another question. If the answer is NO, processing ends at 620. If the answer is YES, processing continues at decision block 608, where it is determined whether n cycles of the judgment process have been completed since the last time the human/machine test was given. If the answer is NO, processing continues at block 610 where processing is continued as described from that point above. If the answer is YES, processing returns to decision block 606, where the human/machine test is given again. Processing continues from that point as previously described above.

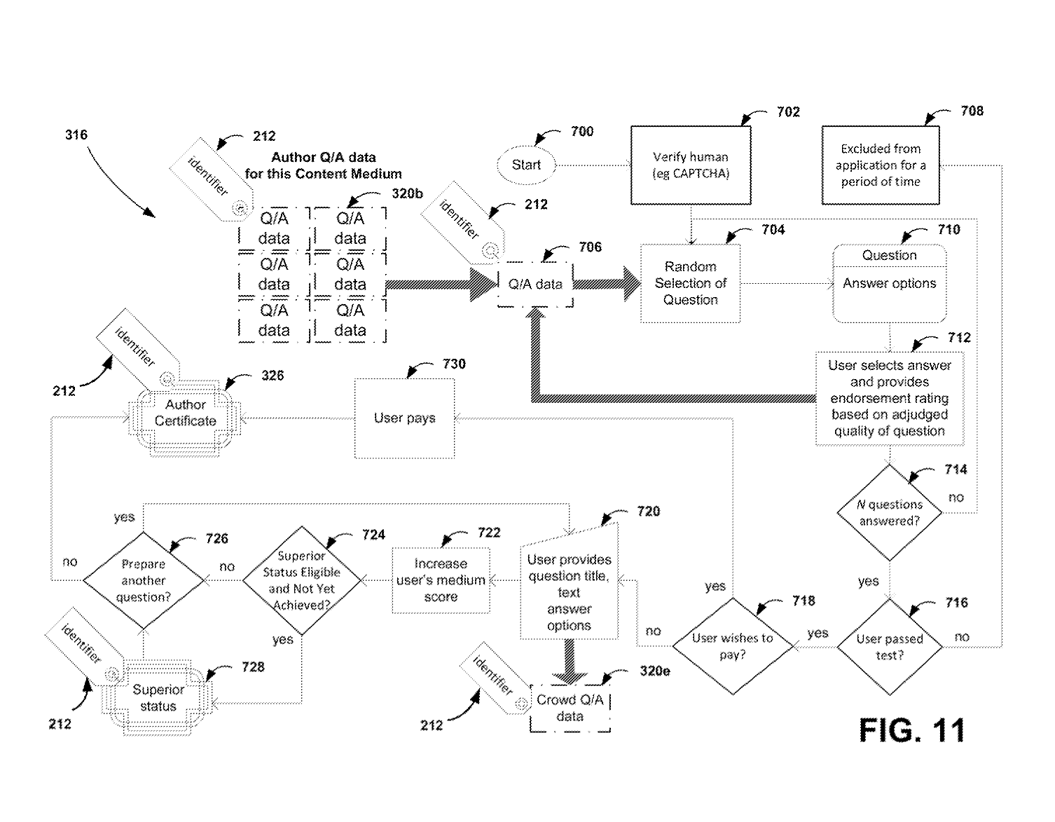

A user viewing a Content Medium Page 210 can also invoke the Author Certificate Test Engine 316, which is illustrated by the procedural flow diagram of FIG. 11. A user activates the Author Certificate Test Engine 316 by activating the Apply for Author Certificate link button 308 as presented on Content Medium Page 210, as illustrated in FIG. 3 and FIG. 7. Once invoked, processing begins at 700, where processing proceeds to block 702 where the user is verified as a human and not a machine in a manner such as that previously described above with respect to the other engines.

Once the user is verified as human and not machine, process continues at block 704, where a question is randomly selected from what can be a subset 706 of the questions prepared (using the Author component 312b of Question Preparation Engine 312 as described above) by a verified author of the content medium associated with the Content Medium Page 210 from which the Author Certificate Test Engine 316 has been invoked. The randomly selected question is drawn from all of the available Author Question and Answer Data 320b stored in database 330, and which is linked with identifier 212 to the Content Medium Page 220.

Processing continues at 710 where the Question and answers are presented to the user through the user's browser. Processing continues at block 712 where the user selects an answer and provides a endorsement rating for the question. The endorsement rating information is associated with the question and answer data and is ultimately stored back into database 330. In an embodiment, endorsement ratings for questions prepared by authors are not used for personal reputation scores such as endorsement ratings for questions prepared by crowd users, but can be used for evaluation purposes such as to determine which questions might be problematic.

Processing continues at decision block 714, where it is determined whether the total number of questions has been answered. If the answer is NO, processing continues back at block 704 and proceeds until the minimum number of questions has been answered. When the answer is YES, processing continues at decision block 716, where it is determined whether the user answered correctly the required minimum number of the questions to pass the test. If the answer is NO, processing continues to block 708, where the user is excluded from taking the test again for some predetermined period of time. This can be accomplished by deactivating the Apply for Author Certificate link button 308 whenever the user selects the Content Medium Page for that predetermined period of time.

If the answer is YES, processing continues at decision block 718 where the user can be given the choice of whether to pay for the Author Certificate, or to contribute to the community by preparing questions to be used for Crowd Certificate testing for the content medium. If the user chooses to pay, processing continues at block 730 where the user's payment is taken, and at block 326, an Author Certificate is issued to the user and processing ends. The Author Certificate 326 is tagged with identifier 212 so that it is associated with the content medium of the Content Medium Page 210. The Author Certificate is also tagged with the user's information, and will now be listed with the user's My Certificates page.

If the user chooses to prepare questions, processing proceeds at block 720, where the user contributes a question title, question text and question answers to the overall Crowd Question and Answer data 320e, and which is tagged with identifier 212 and stored in database 330. Processing continues at block 722, where the user's content medium score for the topic or content associated with the Content Medium Page 210 from which Author Certificate Test Engine 316 was launched is increased. Those of skill in the art will recognize that increasing the user's score for the user's contribution to the community incentivizes the user to make such contributions for the benefit of the community.

Processing continues at decision block 724, where it is determined the user qualifies for or does not already own Superior status for the content or topic associated with the current Content Medium Page 210. If the answer to both questions is YES, processing continues at block 728 where Superior status is awarded to the user, and the information regarding the user's Superior status along with the identifier tag 212 is stored in database 330 of system 600.

If the answer is NO to either question at decision block 724, processing continues at decision block 726 where it is determined whether the user wishes to prepare and submit another question. If the answer is NO, the process ends at 326 where the user is awarded the Author Certificate. If the answer is YES, processing returns to decision block 720 and processing continues as previously described above from that point.

Those of skill in the art will appreciate that blocks 720, 320e, 722, 724, 726 and 728 of Author Certificate Test Engine 316 are largely equivalent to blocks 414, 320a, 416, 420, and 424 of the Crowd Question Preparation Engine (312a, FIG. 8) Thus, these functions shown as part of Author Certificate Test Engine 316 could be implemented as part of the Author Question Preparation Engine 312a, with a call to the Crowd Question Preparation Engine 312a at block 720, FIG. 11). They are shown as part of the Author Certificate Test Engine 316 out of convenience of illustration.

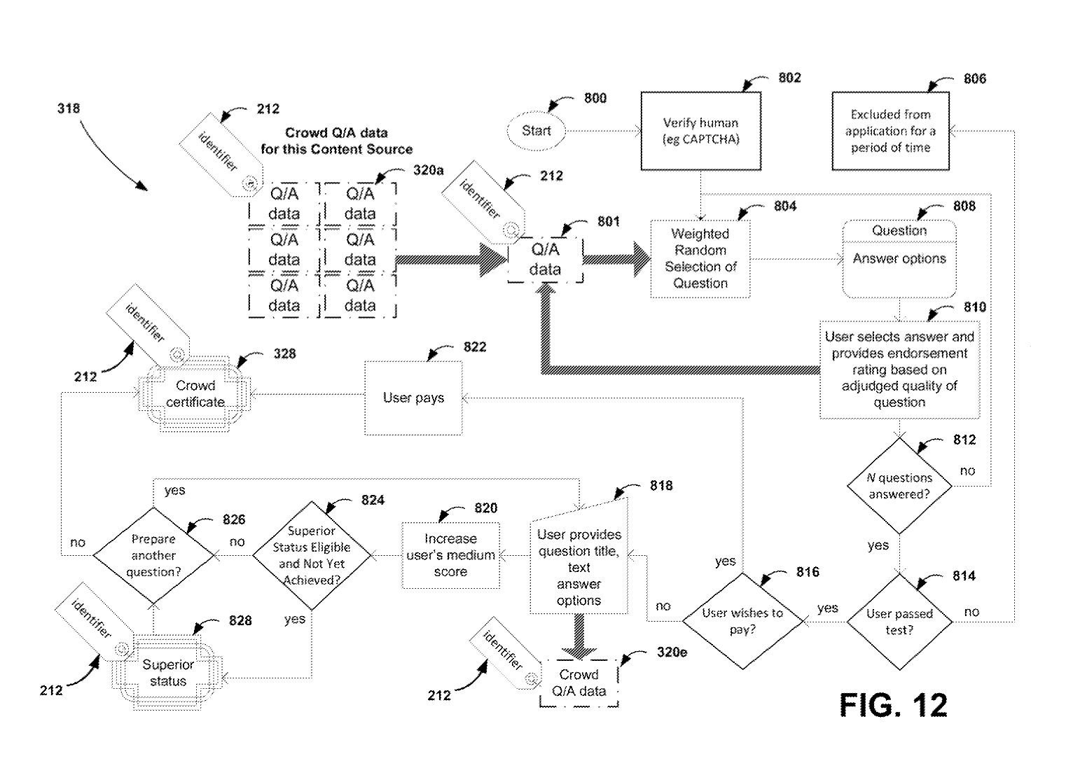

A user viewing a Content Medium Page 210 can invoke the Crowd Certificate Test Engine 318, which is illustrated by the procedural flow diagram of FIG. 12. A user activates the Crowd Certificate Test Engine 318 by activating the Apply for Crowd Certificate link button 310 as presented on Content Medium Page 210, and as illustrated in FIG. 3 and FIG. 7. Once invoked, processing begins at 800, where processing proceeds to block 802 where the user is verified as a human and not a machine in a manner such as that previously described above with respect to the other engines.

Once the user is verified as human and not machine, process continues at block 804, where a question is selected from what can be a subset 801 of the questions prepared (using the Crowd component 312a of Question Preparation Engine 312 as described above) by a user. The selection can be a random selection but weighted by Endorsement Score, thus favoring selection of those questions that have received a more favorable judgment rating by other users. The selected question is drawn from all of the available Crowd Question and Answer Data 320a stored in database 330, and which is linked with identifier 212 to the Content Medium Page 220.

Processing continues at 808 where the Question and answers are presented to the user through the user's browser. Processing continues at block 810 where the user selects an answer and provides a endorsement rating for the question. The endorsement rating information is associated with the question and answer data and is ultimately stored back into database 330. In an embodiment, endorsement ratings for questions prepared by crowd (i.e. non-authors) are used for determining personal reputation, and can also be used for evaluation purposes such as to determine which questions might be problematic and which should be culled from the database 330 altogether.

Processing continues at decision block 812, where it is determined whether the total number of questions n has been answered. If the answer is NO, processing continues back at block 804 and proceeds until the requisite minimum number of questions has been answered. When the answer is YES, processing continues at decision block 814, where it is determined whether the user answered correctly the required minimum number of the questions to pass the test. If the answer is NO, processing continues to block 806, where the user is excluded from taking the test again for some predetermined period of time. This can be accomplished by deactivating the Apply for Crowd Certificate link button 310 whenever the user selects the Content Medium Page 210 for that predetermined period of time.

If the answer is YES, processing continues at decision block 816 where the user can be given the choice of whether to pay for the Crowd Certificate, or to contribute to the community by preparing questions to be used for Crowd Certificate testing for the content medium. If the user chooses to pay, processing continues at block 822 where the user's payment is taken, and at block 328, a Crowd Certificate is issued to the user and processing ends. The Crowd Certificate 328 is tagged with identifier 212 so that it is associated with the content medium of the Content Medium Page 210. The Crowd Certificate is also tagged with the user's information, and will now be listed with the user's My Certificates page.

If the user chooses to prepare questions, processing proceeds at block 818, where the user contributes a question title, question text and question answers to the overall Crowd Question and Answer data 320e, and which is tagged with identifier 212 and stored in database 330. Processing continues at block 820, where the user's content medium score for the topic or content associated with the Content Medium Page 210 from which Crowd Certificate Test Engine 318 was launched is increased. Those of skill in the art will recognize that increasing the user's score for the user's contribution to the community incentivizes the user to make such contributions for the benefit of the community.

Processing continues at decision block 824, where it is determined the user qualifies for or does not already own Superior status for the content or topic associated with the current Content Medium Page 210. If the answer to both questions is YES, processing continues at block 828 where Superior status is awarded to the user, and the information regarding the user's Superior status along with the identifier tag 212 is stored in database 330 of system 600.

If the answer is NO to either question at decision block 824, processing continues at decision block 826 where it is determined whether the user wishes to prepare and submit another question. If the answer is NO, the process ends at 328 where the user is awarded the Crowd Certificate. If the answer is YES, processing returns to decision block 818 and processing continues as previously described above from that point.

Those of skill in the art will appreciate that blocks 818, 320e, 820, 824, 826 and 828 of Crowd Certificate Test Engine 318 are largely equivalent to blocks 414, 320a, 416, 420, and 424 of the Crowd Question Preparation Engine (312a, FIG. 8) Thus, these functions shown as part of Crowd Certificate Test Engine 318 could be implemented as part of the Crowd Question Preparation Engine 312a, with a call to the Crowd Question Preparation Engine 312a at block 818, FIG. 12. They are shown as part of the Crowd Certificate Test Engine 318 out of convenience of illustration.

Based on the foregoing, those of skill in the art will appreciate that the system of the invention can be employed to establish a community that can provide its members the ability to become certified in virtually any number of content media or topics. Through the system of the invention, the users of the community are able to self-generate a virtually unlimited database of content media and topics by which any other member can become certified, along with the questions and answers that can be used to provide the certification of the knowledge regarding those content media and topics. Moreover, the nature of the certification can be defined in virtually any way imaginable. Certificates can be established with standards established by the members of the community at large, by authors of content media, by educators and associations. Such individual certificates can even be organized and aggregated to establish degrees.

Users are incentivized to initiate content medium pages for certification, to prepare questions for certification, to judge the value of each other's questions, and to share their certificates with employers, other users, and contacts on virtually any social media website. They are provided scores with respect to each content medium or topic, overall scores indicating their overall reputation in the community, and could even be paid. In this way, test questions are constantly being refined and improved, and thus the value of the certification for each content medium or topic becomes greater. Users are able to self-educate themselves on virtually any content medium or topic, while being provided with a means for certifying their self-acquired knowledge without the need to attend ever more expensive traditional or even online educational institutions for that certification.

It will be appreciated that the site can further incentivize participation through monetary payments that can be commensurate with a user's level of participation. For example, users with higher endorsement scores and medium scores can be paid, or paid more, for their preparation and judging of questions. The funds can be generated based upon payments made into the community by other users who seek certification but who would rather pay for their certificates than take the time to prepare or judge questions. Advertising revenue can also be used for this purpose. Finally, even peer-to-peer payment mechanisms can also be established. The website can also use some of the collected revenues to support the expenses necessary to host and maintain the website for the community. Payment could be made by traditional currency, or digital/virtual currencies such as bitcoin.

Authors of content media will be able to more directly participate in the certification of the knowledge of those purchasing their content media, while creating a much greater market for their media in the process.

Finally, the system of the invention can provide a convenient and automated platform for testing users, even when applied to a more conventional educational paradigm.

What is claimed is:

1. A system for providing online community-based certification of a user's knowledge of content embodied in a content medium, the system comprising:
a database for storing information descriptive of each of a plurality of content media and the content embodied therein at the request of one or more users of the community, the descriptive information for each content medium of the plurality being associated with a unique content medium page;
at least one computer processing device coupled to the database, the computer processing device accessible to the users over a network;
a question preparation engine, executed by the at least one processing device at the request of a user, to enable the requesting user to prepare test questions and associated answer options concerning the content embodied in at least one content medium of the plurality;
a question judgment engine, executed by the at least one processing device at the request of a user, to enable the requesting user to assign an endorsement rating to questions prepared by other users of the community through the question preparation engine for at least one content medium of the plurality; and
at least one certificate test engine, executed by the at least one processing device at the request of a user, to enable the requesting user to apply for a certificate for at least one content medium of the plurality for which a minimum number of questions and associated answer options have been prepared, the at least one certificate test engine granting ownership of the certificate for which the user applies if the user correctly answers a predetermined number of the prepared questions.

2. The system of claim 1 wherein execution of the question preparation engine, the question judgment engine and the at least one certificate test engine can each be initiated by a user by activating a link associated with a content medium page displayed on a user's personal processing device.

3. The system of claim 1 wherein the question preparation engine can be initiated by a user claiming to be an author of the content embodied in the content medium to prepare author certification questions and answer options to test a user's knowledge of the content.

4. The system of claim 1 wherein the question preparation engine can be initiated by a non-author of the content embodied in the content medium to prepare crowd certification questions and answer options by which to test a user's knowledge of the content.

5. The system of claim 3 wherein the at least one certificate test engine includes an author certificate test engine that can be initiated by a user to apply for an author certificate, the author certificate test engine presenting one or more author certification questions and associated answer options to the user, the author certificate test engine granting the user ownership of the requested author certificate if the user correctly answers a predetermined number of the prepared author certification questions presented.

6. The system of claim 4 wherein the at least one certificate test engine includes a crowd certificate test engine that can be initiated by a user to apply for a crowd certificate, the crowd certificate test engine presenting one or more crowd certification questions and associated answer options to the user, the crowd certificate test engine granting the user ownership of the requested crowd certificate when the user correctly answers a predetermined number of the prepared crowd certification questions presented.

7. The system of claim 1 wherein each content medium page is stored in the database in association with a descriptor that is created from the information descriptive of the content medium and the content embedded therein, and an identifier unique to the content medium.

8. The system of claim 7 wherein the information descriptive of the content medium from which the descriptor is created is obtained from a source connected to the Internet in response to a search conducted by a user.

9. The system of claim 7 wherein the information descriptive of the content medium from which the descriptor is created is obtained from information provided by a user using a form presented to the user through the user's browser.

10. The system of claim 7 wherein for each content medium, the content medium page, the questions and associated answer options prepared by users through the question preparation engine, endorsement ratings provided for the prepared questions and answer options, and certificates granted by the at least one test certificate engine are stored in the database in association with the unique identifier for the content medium.

11. The system of claim 6 wherein the crowd certification questions and associated answer options presented by the crowd certificate test engine are those crowd certificate test questions having an endorsement score that exceeds a predetermined level and are randomly presented with a weighted probability based on their respective endorsement scores.

12. The system of claim 1 wherein the question preparation engine, the question judgment engine, and the at least one certificate test engine are initiated by a user from the content medium page by the user activating links that are displayed on the content medium page when it is displayed on the user's browser.

13. The system of claim 1 wherein a content medium page can be associated with a general topic rather than content embodied in a specific content medium, the questions and associated answer options prepared using the question preparation engine concerning the general topic being designed to test a user's knowledge concerning the topic generally.

14. The system of claim 1 wherein all certificates granted to a user through the at least one certificate test engine being displayed on a “Your Certificates” page displayed on the user's browser at the request of the user.

15. The system of claim 1 wherein all certificates granted to a user through the at least one certificate test engine can be shared using a link unique to each granted certificate.

16. The system of claim 3 wherein the question preparation engine further includes author validation that stores an indication of validation for any prepared author certification questions and answer options prepared by a user alleging authorship of the content medium and stored in the database.

17. The system of claim 1 wherein each user is provided with a medium score for each content medium that is at least based on the number of questions the user has prepared for the content medium and the number of questions that the user has judged that were prepared by other users.

18. The system of claim 1 wherein each user is provided with a reputation score that is at least based on an average endorsement score attributed to all of the questions prepared for all content media by the user, as judged by other users.

19. The system of claim 1 wherein the question preparation engine is configured to issue a pre-certificate to at least one user for a content medium when an insufficient number of questions has been prepared by which a user's knowledge of the content embodied in the content medium can be sufficiently tested.

20. The system of claim 1 wherein the at least one certificate test engine is configured to provide a user ownership of a granted certificate in exchange for either a predetermined payment or preparation of a predetermined number of test questions and associated answer options concerning the content embodied in the content medium for which the certificate is granted.
